(19) United States
(12) Patent Application Publication
(10) Pub. No.: US 2024/0249068 A1
(43) Pub. Date: Jul. 25, 2024

(54) ABSTRACTIVE CONTENT TRANSFORMATION

(71) Applicant: Microsoft Technology Licensing, LLC, Redmond, WA (US)

(72) Inventors: Warren A. ALDRED, Redmond, WA (US); Si-Qing CHEN, Bellevue, WA (US); Rama S. GANESAMOORTHY KASTHURI, Sammamish, WA (US); Xun WANG, Amherst, MA (US); Weixin CAI, Kirkland, WA (US); Xinyu HE, Lynnwood, WA (US); Xingxing ZHANG, Beijing (CN); Zhang LI, Bellevue, WA (US); Kaushik R. NARAYANAN, Bellevue, WA (US); Furu WEI, Beijing (CN); Cheng YANG, Bellevue, WA (US)

(21) Appl. No.: 18/564,349

(22) PCT Filed: Jun. 24, 2021
(86) PCT No.: PCT/CN2021/102208

§ 371 Date: Nov. 27, 2023

(51) Int. Cl. G06F 40/166; G06F 16/34; G06Q 10/107

(52) U.S. Cl. CPC G06F 40/166; G06F 16/345; G06Q 10/107

(57) ABSTRACT

A sequence-to-sequence summarizer receives source content to be summarized and determines whether the source content has a size that meets the size threshold. If so, the source content is divided into sections and the sequence-to-sequence summarizer generates a summary for each section. The summaries for each section are merged into a document summary and surfaced for user interaction.

### BACKGROUND

Computing systems are currently in wide use. Some such computing systems include productivity systems or other computing systems that display or otherwise surface content for a user to read.

In fact, due to the very nature of current computing systems, textual content (such as documents) is so ubiquitous and lengthy that finding a document relevant to a user can be cumbersome and extremely time consuming. Therefore, some current computing systems include summarization systems that attempt to summarize documents.

The discussion above is merely provided for general background information and is not intended to be used as an aid in determining the scope of the claimed subject matter.

### SUMMARY

A sequence-to-sequence summarizer receives source content to be summarized and determines whether the source content has a size that meets a size threshold. If so, the source content is divided into sections and the sequence-to-sequence summarizer generates a summary for each section. The summaries for each section are merged into a document summary and surfaced for user interaction.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of a client computing system that includes a summary generation computing system.

FIG. 2 is an example of a user interface display showing a summary generation actuator.

FIG. 3 is a user interface display showing an example of a summary generated for a source document.

FIGS. 4A and 4B (collectively referred to herein as FIG. 4) show a flow diagram illustrating one example of the operation of a summary generation computing system in generating a summary of a source document.

FIG. 5 is a flow diagram illustrating the generation of a summary of an electronic mail (email) thread.

FIG. 6 is a block diagram showing one example of a model training computing system.

FIG. 7 is a block diagram showing one example of the operation of a model training computing system in generating a teacher model.

FIG. 8 is a flow diagram illustrating one example of the operation of a model training system in using a teacher model to generate a sequence-to-sequence summarizer.

FIG. 9 is a block diagram showing one example of a remote server architecture.

FIGS. 10-12 show examples of mobile devices that can be used in architectures described herein.

FIG. 13 is a block diagram showing one example of a computing environment that can be used in the architectures and systems illustrated in the previous figures.

### DETAILED DESCRIPTION

As discussed above, some current computing systems attempt to generate document summaries for source documents. However, such document summarization systems often use large document summarizing models that take a great deal of computing system resources and are relatively long latency models. Also, it is not uncommon for users of email systems to engage in rather lengthy exchanges thus creating a long email thread. When a new user wishes to join the email discussion, it is difficult to summarize all of the messages in the email thread for the new user. It can be cumbersome to obtain summaries for source content that is contained in multiple different documents, such as in an email thread or in a list of documents, in an electronic mail (email) thread, or other such sources. Similarly, it can be very cumbersome to obtain training data for document summarizers.

The present discussion thus proceeds with respect to a system that uses a relatively large machine-learned model to generate training data for a sequence-to-sequence summarizer that can be deployed for use by client computing systems to quickly and accurately generate summaries of source content. The present description also proceeds with respect to a system that can quickly summarize multiple documents in a list of documents and multiple email messages in an email thread.

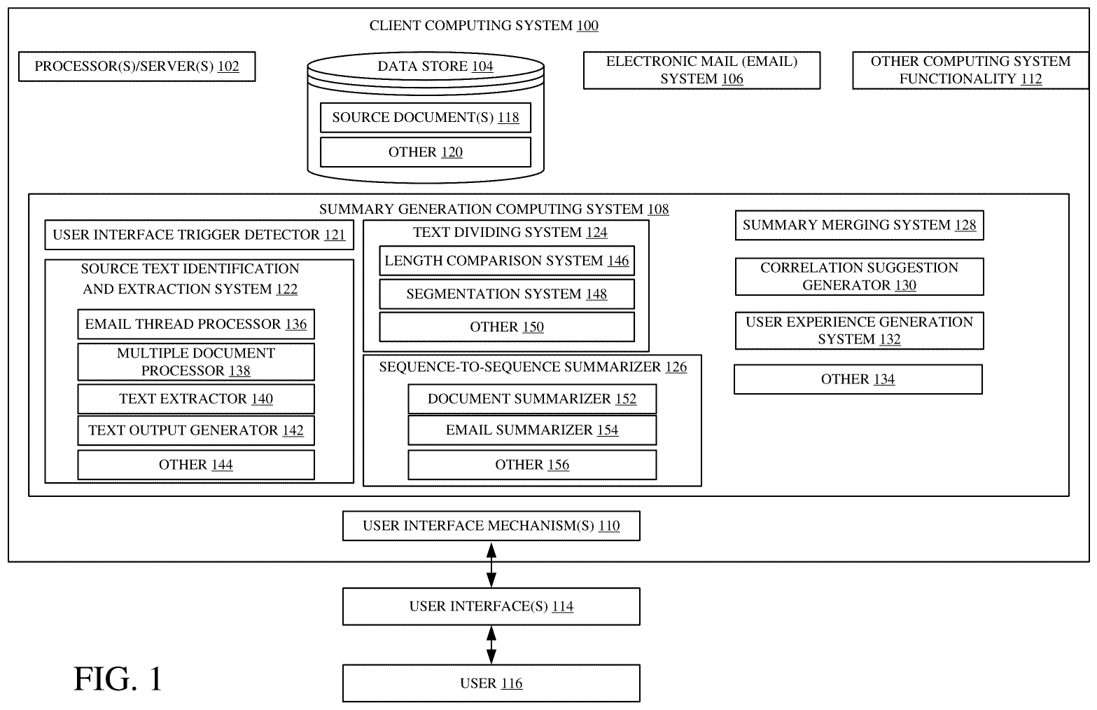

FIG. 1 is a block diagram of one example of a client computing system 100. Client computing system 100 illustratively includes one or more processors or servers 102, data store 104, electronic mail (email) system 106, summary generation computing system 108, one or more user interface mechanisms 110, and any of a wide variety of other computing system functionality 112. FIG. 1 also shows that user interface mechanisms 110 can generate user interfaces 114 for interaction by user 116. User 116 can interact with user interfaces 114 in order to control and manipulate certain portions of client computing system 100. It will also be noted that while summary generation computing system 108 is shown on a client computing system 100, it could just as easily be a cloud-based computing system, a system exposed as a service, or in another computing system.

Before describing the overall operation of client computing system 100, a brief description of some of the items in client computing system 100 and their operation will first be provided. In the example shown in FIG. 1, data store 104 illustratively includes source documents 118 and it can include other items 120. Summary generation computing system 108 includes user interface trigger detector 121, source text extraction system 122, text dividing system 124, sequence-to-sequence summarizer 126, summary merging system 128, correlation suggestion generator 130, user experience generation system 132, and other items 134. Source text extraction system 122 can include email thread processor 136, multiple document processor 138, text extractor 140, text output generator 142, and other items 144. Text dividing system 124 can include length comparison system 146, segmentation system 148, and other items 150. Sequence-to-sequence summarizer 126 can include document summarizer 152, email summarizer 154, and other items 156.

Email system 106 can be a client component of a hosted email system or another email system. In one example, email system 106 provides user 116 with access to email functionality through user interfaces 114.

User interface trigger detector 121 detects a user input from user 116 or another trigger indicating that a source document is to be summarized. For example, user interface trigger detector 121 can generate a user interface actuator on a user interface display 114 that can be actuated by user 116. Actuation of the user interface actuator can be detected by trigger detector 121 as an indication that user 116 wishes a document or other source content to be summarized. Source text identification and extraction system 122 then identifies the source content or source document to be summarized and extracts text from the source document for summarization. If the source content to be summarized is an email thread, this is identified by email thread processor 136. For instance, it may be that user 116 is viewing a mailbox on user interfaces 114 where the user actuates the summarization actuator. In that case, email thread processor 136 parses the email thread to identify the content of the email messages and use text extractor 140 to extract the text from the message. Email thread processor 136 can also obtain the sender and recipients of that content. The separate items of content can be identified and metadata identifying their sender and recipients can be identified along with other metadata, such as the date and time when the message was sent, among other things. Text output generator 142 provides this text and metadata to text dividing system 124.

If the content to be summarized includes multiple documents, such as documents listed on a list of documents, then multiple document processor 138 detects that. For instance, it may be that user 116 is viewing a list of documents or has selected a list of documents for summarization and actuated the document summarization actuator. Multiple document processor 138 then accesses the selected list of documents and retrieves those documents and uses text extractor 140 to extract the text from those documents. Multiple document processor 138 can also provide the extracted text, along with metadata indicating the source document for the text, to text output generator 142 which provides the information to text dividing system 124.

When the source content to be summarized is a single source document, this may be detected by text extractor 140 which simply extracts the text from the source document to be summarized. Text extractor 140 can provide the extracted text, along with metadata identifying the source document, to text output generator 142. Text output generator 142 can generate an output including the extracted text and corresponding metadata and provide the output to text dividing system 124.

In some scenarios, it may be that the source content is so long that generating a summary for it may involve a latency that is undesirably long. In that case, text dividing system 124 can divide the source content into multiple sections and a summary can be generated for each section. In one example, multiple instances of the sequence-to-sequence summarizer can be deployed to generate summaries for the multiple different sections, in parallel. Length comparison system 146 thus compares the length of the source text to be summarized to a length threshold. The threshold value may vary based upon the particular sequence-to-sequence summarizer being used and based upon the desired maximum latency for a summary to be generated. If the length of the source content meets the threshold value, then segmentation system 148 divides the source content into smaller segments and identifies a sequence value for each segment indicative of the sequence in which the segments appear in the source document. The segments and their corresponding sequence value can then be provided to sequence-to-sequence summarizer 126.

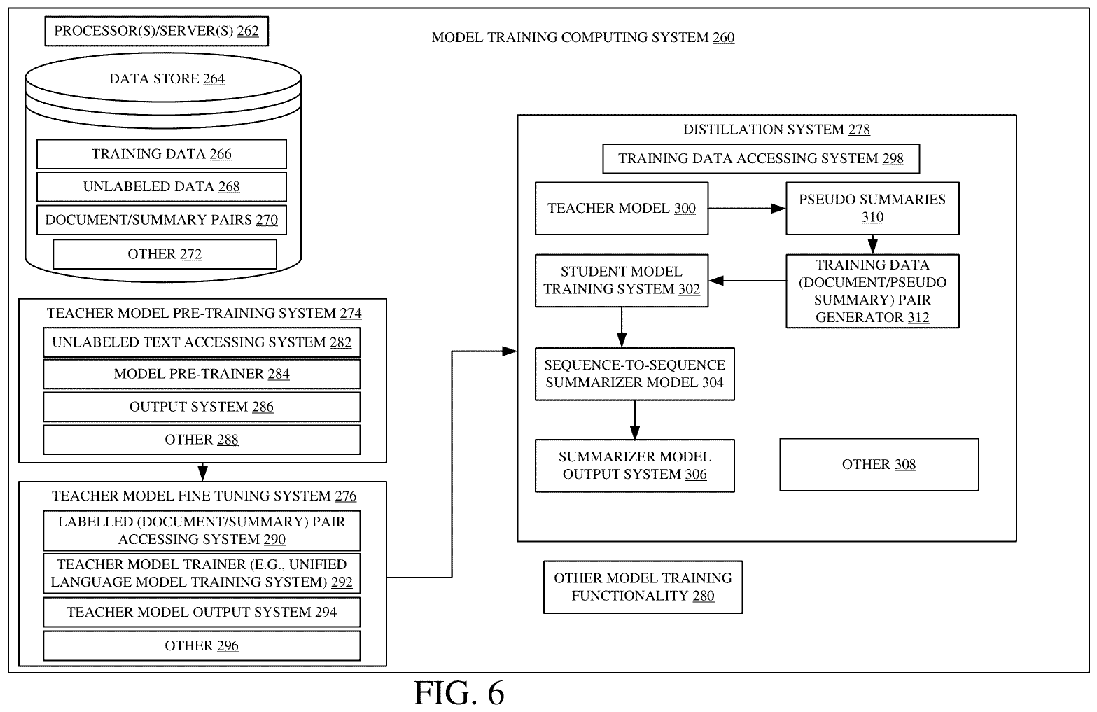

Sequence-to-sequence summarizer 126 is illustratively a relatively small model that operates quickly and, in one example, is trained as described below with respect to FIGS. 6-8. By way of example, summarizer 126 may be an artificial neural network or another classifier that classifies or transforms input text sequences into output text sequences to generate the summary. Where the source content is a document or a set of documents, document summarizer 152 generates a summary corresponding to each document in the source content. In one example, where the documents are divided into sections, document summarizer 152 generates a summary for each section of each document.

Where the source content is an email thread, the email summarizer 154 generates summaries for the email content Email summarizer 154 may, for instance, summarize the content generated by each user in the email thread. Email summarizer 154 may identify unanswered questions in the email thread and identify who is waiting for answers to those questions. Email summarizer 154 may generate an overall summary for the email thread attributing certain portions of the summary to the users that contributed to the corresponding content portion to the conversation reflected in the email thread.

The summaries for different sections of the source content can be provided to summary merging system 128. Summary merging system 128 merges the summaries by eliminating redundant summary content by ordering the summaries of the different sections sequentially based upon the corresponding sequence value, and in other ways.

Correlation suggestion generator 130 can generate a correlation suggestion which indicates how the summary should correlate to the source content. For instance, if the source content is a single document, correlation suggestion generator 130 may generate an output indicating that the summary should be inserted in the source document at the beginning or at the end of the source document or in another place. In one example, the correlation can be edited by user 116 so that user 116 may change where the summary appears in the source content. In another example, the correlation suggestion may be to store the summary at a certain memory location in data store 104 or elsewhere. Again, the location where the summary is stored may be edited by user 116.

User experience generation system 132 then conducts a user experience for user 116 in surfacing the summary and the correlation suggestion. For instance, user experience generation system 132 may surface the summary in an editable form so that user 116 can review and edit the summary, as desired. User experience generation system 132 may also surface the correlation suggestion output by generator 130 so that the user 116 can accept or edit the correlation suggestion (such as the location in memory where the summary is stored, the location in the source content where the summary is inserted, etc.).

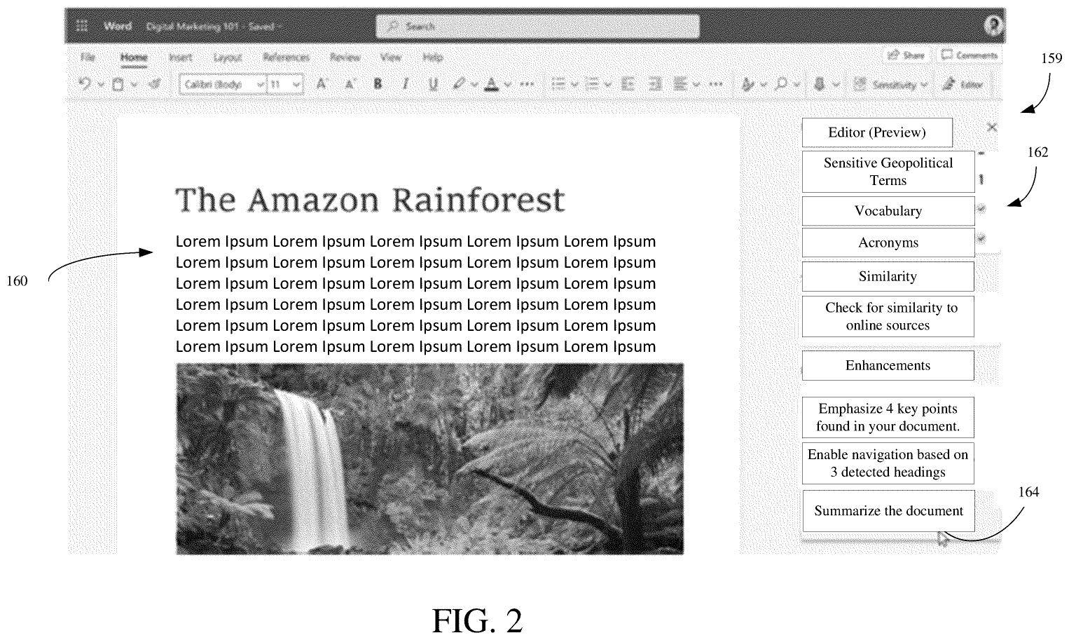

FIG. 2 is one example of a user interface display that can be generated by user interface mechanisms 110. In the example shown in FIG. 2, user 116 has opened an editor pane to edit a document and navigated to a section in which, not only is the document displayed in document display section 160, but a set of controls are displayed in a control panel shown generally at 162. Control panel 162 illustratively includes a summarization actuator 164 which, when actuated by user 116, causes summary generation computing system 108 to generate a summary of the document displayed in document display portion 160. While the summarization text is being generated, system 108 may generate a user interface display element so that user 116 sees a busy indicator or another display element indicating that the summary is being generated.

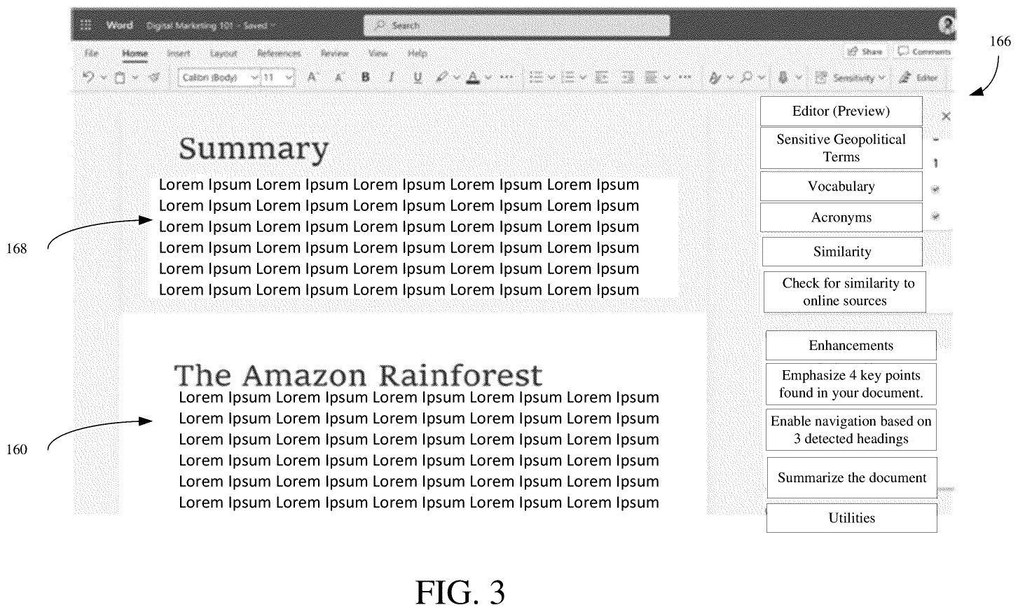

Once the summary is generated, correlation suggestion generator 130 generates a correlation indicating how the summary should be correlated to the source document that was used to generate the summary. FIG. 3 shows a user interface display 166 showing that the summary is displayed in a summary display section 168 that is inserted at the top of the document displayed in the document display section 160. In one example, user interface display 166 may provide actuators that allow user 116 to modify the summary or to change where it is placed relative to the document, or to provide other inputs.

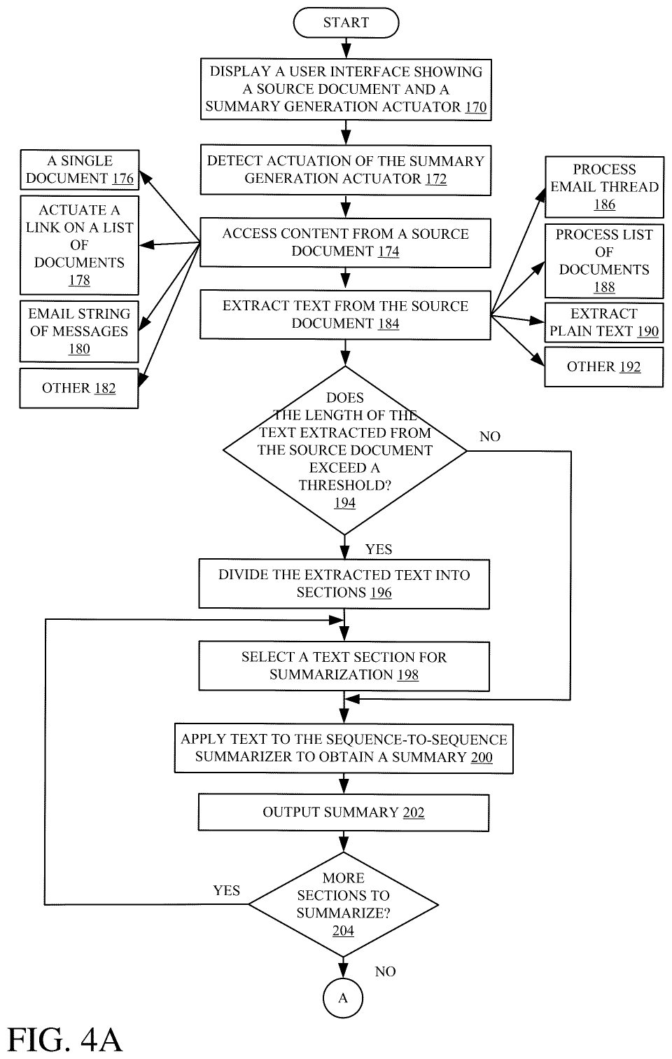

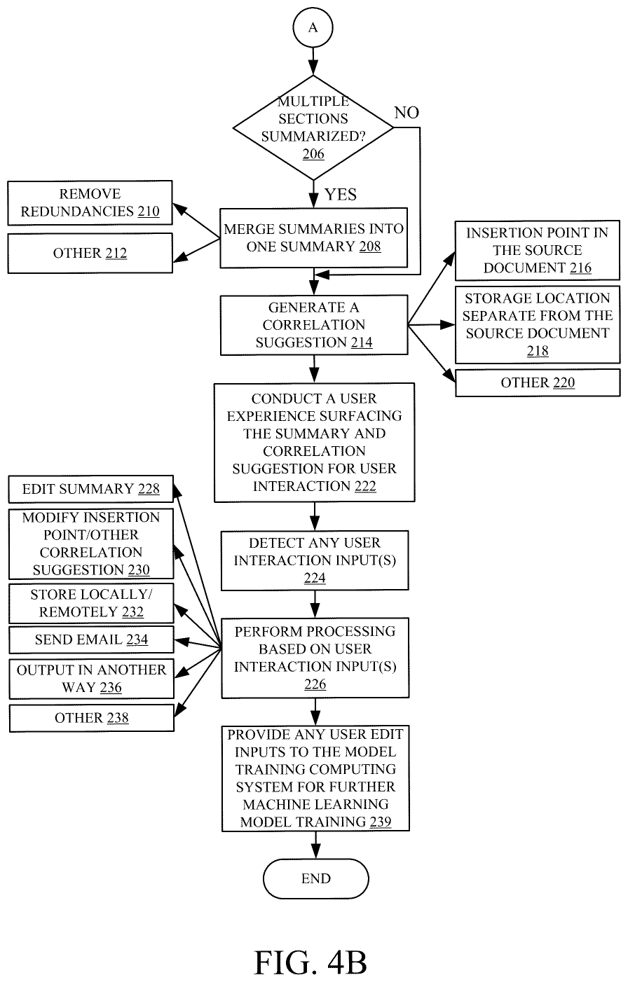

FIGS. 4A and 4B (collectively referred to as FIG. 4) show a flow diagram illustrating one example of how summary generation computing system 108 can generate and display a summary of an underlying document or other source content. It is first assumed that user 116 is viewing a document on a user interface 114. User experience generation system 132 displays a user interface also showing a summary generation actuator that can be actuated to trigger summary generation computing system 108 to generate a summary. Displaying a user interface display showing the source document and a summary generation actuator is indicated by block 170 in the flow diagram of FIG. 4.

User interface trigger detector 121 then detects user actuation of the summary generation actuator, as indicated by block 172. Source text identification and extraction system 122 then accesses content from the source document, as indicated by block 174. As discussed above, the source document can be a single document 176. The source document can also be a list of documents with a set of links to the individual documents in the list, as indicated by block 178. The source document can be an email thread of messages 180, or another source document 182. Source text identification and extraction system 122 then extracts the text to be summarized from the source document, as indicated by block 184. If the document is an email string of messages 180 then email thread processor 136 processes the email thread to identify the content of the messages, and the metadata indicative of the senders and recipients of the messages. Processing the email messages to identify the content and metadata corresponding to the content, (such as the sender and recipients, the sequence in which the messages were sent, among other things), is indicated by block 186 in the flow diagram of FIG. 4.

Where the source document is a list of documents 178, then multiple document processor 138 processes the list of documents, such as by actuating the link to each document and extracting the content of each document, along with metadata identifying the source document. Processing the list of documents is indicated by block 188 in the flow diagram of FIG. 4. Text extractor 140 can be used to extract plain text from a single document, from each document in a list of documents, from each email message in a thread of email messages, or other sources. Extracting plain text is indicated by block 190 in the flow diagram of FIG. 4. The text from the source documents can be extracted in other ways as well, as indicated by block 192.

Source text identification and extraction system 122 then generates a payload containing the document text along with any other metadata and sends it to text dividing system 124. For each source document, length comparison system 146 compares the length of the text content for that source document to a threshold level or applies another model to determine whether the text should be broken into different segments. Determining whether the text should be broken into different segments is indicated by block 194 in the flow diagram of FIG. 4. If so, segmentation system 148 divides the extracted text into different segments of a desired length, so that the summary can be generated more efficiently. Dividing the extracted text into sections is indicated by block 196 in the flow diagram of FIG. 4.

Sequence-to-sequence summarizer 126 then obtains a text section for summarization. If, at block 194, the text is not segmented, then the selected text section for summarization is the entire set of text from the source document. If the text is segmented, then the selected section for summarization is a selected one of the text segments, as indicated by block 198. It will be noted that, where the text to be summarized is segmented into different sections, those sections can be summarized simultaneously (e.g., in parallel), or sequentially, or in other ways. They are described as being summarized sequentially for the sake of example only.

Sequence-to-sequence summarizer 126 then generates a summary for the selected segment of text. Where the text is from a document, document summarizer 152 generates a summary for the text. Where the text is from an email, email summarizer 154 generates the summary. The summarizers may be different, because of the nature of content found in different types of source documents. In another example, the same sequence-to-sequence summarizer can be used for the source text, regardless of the source document that it came from. Applying the sequence-to-sequence summarizer to obtain a summary is indicated by block 200 in the flow diagram of FIG. 4. Summarizer 126 then generates an output outputting the summary for the corresponding section of text, as indicated by block 202.

If there are more segments to summarize for the current source content, processing reverts to block 198 where the next text section is selected for summarization. Determining whether there are more sections to summarize is indicated by block 204 in the flow diagram of FIG. 4. If multiple sections have been summarized for the source content, as indicated by block 206, then summary merging system 128 merges the summaries into one summary, as indicated by block 208. Merging can include reducing or eliminating redundancy, rearranging summarized portions based upon the sequence of the sections, as they appeared in the source document, or other ways of merging the summaries. Removing redundancies is indicated by block 210 and merging in other ways is indicated by block 212.

Correlation suggestion generator 130 then generates a correlation suggestion indicating how the summary may correlate to the source document. Generating a correlation suggestion is indicated by block 214. The correlation suggestion may be a suggested insertion point in the source document. For instance, the correlation suggestion may be to insert the summary at the beginning of the document, at the end of the document, or elsewhere. Suggesting an insertion point in the source document is indicated by block 216. The correlation suggestion may be a suggestion to store the summary separate from the source document, but in a given location where it can be accessed quickly when the source document is accessed. Suggesting a correlation indicating the storage location of the summary is indicated by block 218. The correlation suggestion can be a wide variety of other correlations, as indicated by block 220.

User experience generation system 132 then conducts a user experience to surface the summary and the correlation suggestion for user interaction. Surfacing the summary and the correlation suggestion is indicated by block 222 in the flow diagram of FIG. 4. The summary and correlation suggestion may include user actuatable mechanisms, such as actuators, edit input mechanisms or other input mechanisms that allow user 116 to interact with the summary and suggested correlation. The user interactions may be detected by user experience generation system 132 through user interface mechanisms 110. Detecting the user interaction inputs is indicated by block 224 in the flow diagram of FIG. 4.

User experience generation system 132 then performs any processing based upon the user interaction input, as indicated by block 226. For instance, where user 116 provides inputs to edit the summary text, then the summary text is edited, as indicated by block 228. The user interaction input may be to modify the insertion point or other correlation suggestion as indicated by block 230. The user interaction input may be to change where the summary is stored locally or remotely as indicated by block 232 or the user interaction input may be to send an email of the summary, along with the email thread from which the summary was generated, to another email recipient, as indicated by block 234. The user interaction may be to output the summary in another way, as indicated by block 236, or the user interaction input may be another of a wide variety of different user interaction inputs as indicated by block 238.

In one example, user experience generation system 132 provides any user edits or corrections to the model training system that trained sequence-to-sequence summarizer model 136. Machine learning is performed to modify summarizer model 136 based on the edits or correction, as indicated by block 239.

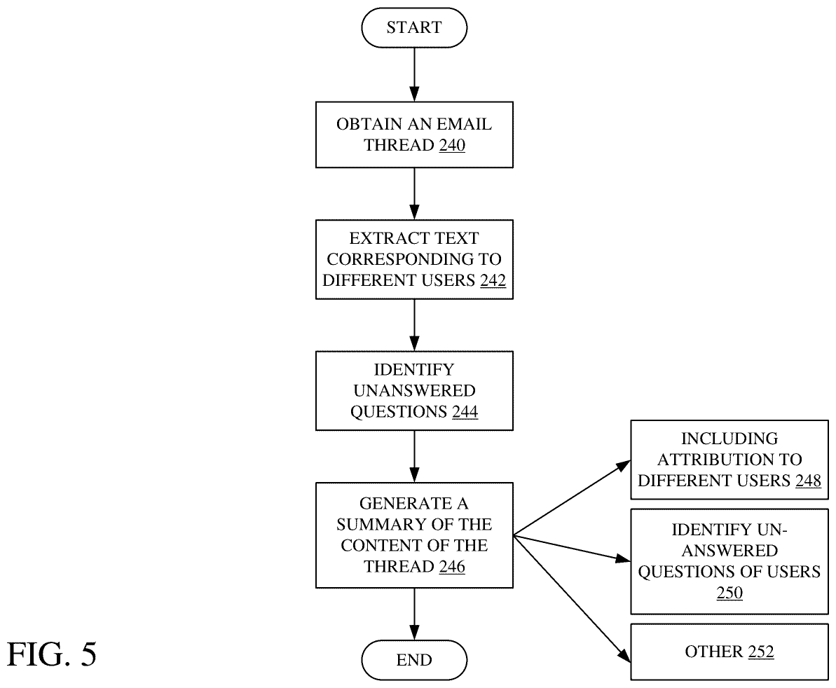

FIG. 5 is a flow diagram illustrating one example of how email summarizer 154 in sequence-to-sequence summarizer 126 may generate a summary for a thread of email messages. Email thread processor 136 obtains an email thread of messages, as indicated by block 240 and extracts text corresponding to different users (e.g., with different senders, recipients, etc.). Extracting the text from the body of the messages, along with metadata identifying the senders, receivers, dates, etc., is indicated by block 242 in the flow diagram of FIG. 5.

In one example, email summarizer 154 identifies any unanswered questions, and the person who asked the questions, in the email thread. Identifying unanswered questions is indicated by block 244 in the flow diagram of FIG. 5.

Email summarizer 154 then generates a summary of the content of the email thread, as indicated by block 246. The summary can include attribution of different portions of the summary to different users (e.g., different senders of email messages), as indicated by block 248. The summary can identify unanswered questions of users, as indicated by block 250 and a wide variety of other information or metadata as indicated by block 252.

FIG. 6 is a block diagram of one example of a model training computing system 260 that can be configured to train sequence-to-sequence summarizer 126. Computing system 260 can include one or more processors or servers 262, data store 264 (which can include labeled training data 266, unlabeled data 268, document/summary pairs 270, and other items 272), teacher model pre-training system 274, teacher model fine tuning system 276, distillation system 278, and a wide variety of other model training functionality 280. Teacher model pre-training system 274 can include unlabeled text accessing system 282, model pre-trainer 284, output system 286, and other items 288. Teacher model fine tuning system 276 can include labeled (document/summary) pair accessing system 290, teacher model trainer (e.g., unified language model training system) 292, teacher model output system 294, and other items 296. Distillation system 278 can include training data accessing system 298, teacher model 300, student model training system 302, sequence-to-sequence summarizer model 304, summarizer model output system 306, and a wide variety of other distillation system functionality 308. Teacher model 300 is shown generating pseudo summaries 310 which can be combined with the underlying documents by training data pair generator 312 which generates document/pseudo summary pairs for input to student model training system 302.

Before describing the overall operation of model training computing system 260 in more detail, a brief description of some of the items in system 260 will first be provided.

Teacher model pre-training system 274 obtains unlabeled text or data 268 and performs pre-training on a teacher model which is a relatively large, long latency model. In one example, the teacher model may be a 24-layer model with a hidden size of 1,024 nodes for each layer. Therefore, unlabeled text accessing system 282 obtains unlabeled data 268 and model pre-trainer 284 pre-trains the model using unlabeled data. Output system 286 outputs the pre-trained teacher model to teacher model fine tuning system 276. Labeled pair accessing system 290 then accesses document/summary pairs 270 and provides them, as training data, to teacher model trainer 292. In one example, teacher model trainer 292 is a unified language model training system that trains the teacher model based upon the document/summary pairs obtained by accessing system 290. Once the teacher model output system 294 outputs the trained teacher model 300 to distillation system 278. Because the teacher model 300 is relatively large, complex, and long-latency, the functionality of teacher model 300 is distilled to obtain sequence-to-sequence summarizer model 304 which is much smaller, less complex, and operates with much lower latency than teacher model 300.

Training data accessing system 298 obtains training data 266, which may be unlabeled data, from data store 264 and provides that data to teacher model 300. The summaries generated by teacher model 300 from unlabeled data 268 are referred to as pseudo summaries 310. The pseudo summaries 310 are then paired with the underlying documents from which they were generated by training data pair generator 312. Training data pair generator 312 thus outputs document/pseudo summary pairs as training data to student model training system 302. Thus, teacher model 300 can generate high volumes of highly accurate pseudo summaries 310 which can be paired with their underlying documents to obtain labeled training data that can be used by student model training system 302 to train sequence-to-sequence summarizer model 304. Student model training system 302 can be a machine learning system that generates the sequence-to-sequence summarizer model 304 as an artificial neural network or another classifier or another model that receives a word sequence as an input and generates a different word sequence as an output, wherein the output is a summary of the input.

Sequence-to-sequence summarizer model 304 is then provided to summarizer model output system 306 which can output model 304 for deployment in various ways. In one example, model 304 can be output for deployment at client computing systems, such as client computing system 100. Model 304 can also be deployed in a service to provide summarization services as well. Summarizer model output system 306 can be output in other ways, for deployment in other locations as well.

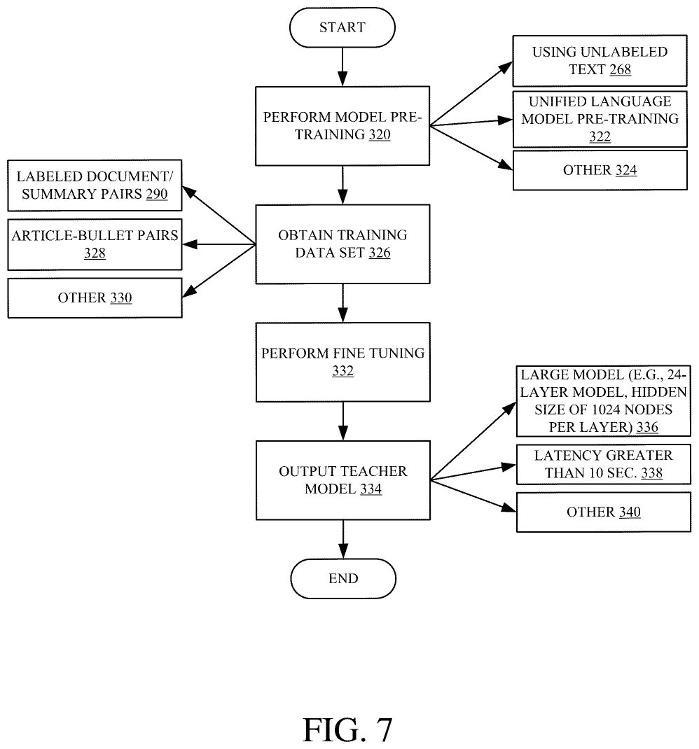

FIG. 7 is a flow diagram illustrating one example of the operation of model training computing system 260 in training teacher model 300. The teacher model 300 is first instantiated and teacher model pre-training system performs pre-training on the model. Performing pre-training is indicated by block 320. Pre-training can be performed using unlabeled data 268, and can be performed using a unified language model pre-training system, as indicated by block 322. Pre-training can be performed using other data and in other ways as well, as indicated by block 324. Labeled pair accessing system 290 then obtains training data sets as indicated by block 326. The labeled training sets can be labeled document/summary pairs 270 from data store 264. In one example, the document/summary pairs are comprised of articles and human-generated bullet points that are published along with those articles. Obtaining article-bullet point pairs is indicated by block 328 in the flow diagram of FIG. 7. The training data set for training teacher model 300 can be obtained in other ways or it can include other data as well, as indicated by block 330.

Teacher model trainer 292 then performs fine tuning of teacher model 300 using the training data set (e.g., the labeled document/summary pairs). Performing fine tune training of model 300 is indicated by block 332 in the flow diagram of FIG. 7.

Teacher model output system 294 then outputs the teacher model 300, as indicated by block 334. The teacher model 300 is, by way of example, a large model 336 that may include 24 layers with a hidden size of 1,024 nodes per layer. This is just one example and other large models 336 can be used as well. In one example, teacher model 300 is a higher latency model that may take in excess of 10 seconds to generate a summary, or longer. The high latency model is indicated by block 338. Teacher model 300 may be any of a wide variety of other types of models 340 as well.

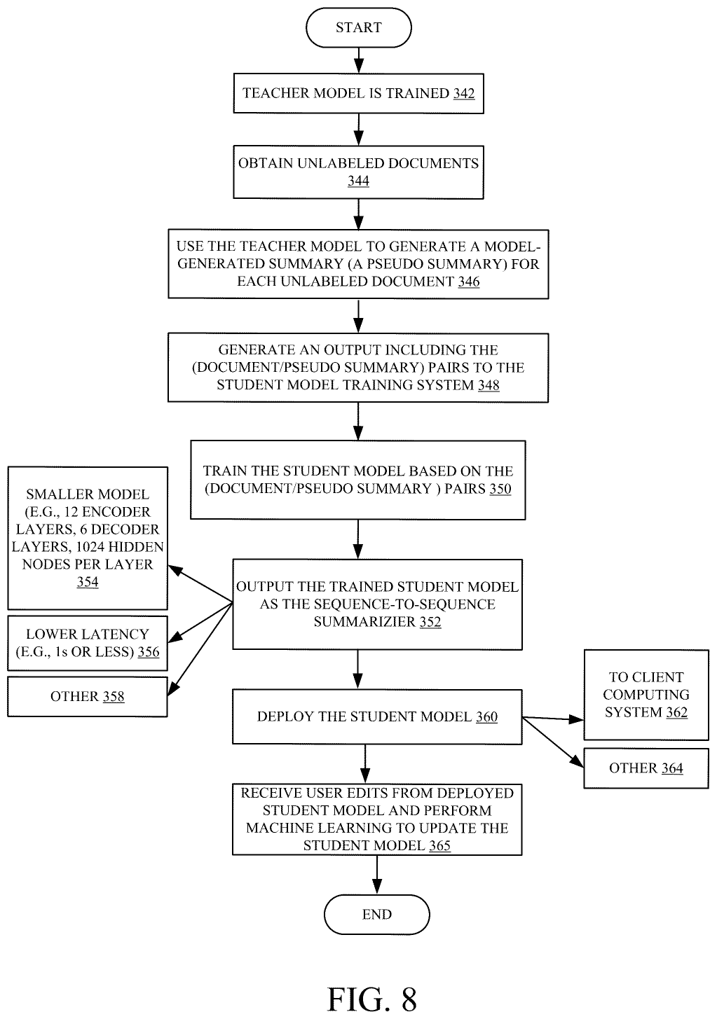

FIG. 8 shows one example of a flow diagram illustrating the operation of distillation system 278 in distilling information from teacher model 300 into sequence-to-sequence summarizer model 304 that is smaller and has lower latency than teacher model 300. It is first assumed that teacher model 300 is trained, as described above, for example. Training the teacher model is indicated by block 342 in the flow diagram of FIG. 8. Training data accessing system 298 then obtains unlabeled documents that can be provided to teacher model 300 for the generation of pseudo summaries 310. Obtaining unlabeled documents is indicated by block 344. The teacher model 300 then generates a model-generated summary (e.g., a pseudo summary 310) for each unlabeled document. Generating the pseudo summaries using teacher model 300 is indicated by block 346.

Training data pair generator 312 then generates an output that pairs the underlying source documents with their pseudo summaries 310 to obtain document/pseudo summary pairs which can be provided to student model training system 302. Generating the document/pseudo summary pairs and providing them to student model training system 302 is indicated by block 348 in the flow diagram of FIG. 8. Student model training system 302 then trains the sequence-to-sequence summarizer model 304 using the document/pseudo summary pairs provided by pair generator 312. Training the sequence-to-sequence summarizer model 304 is indicated by block 350 in the flow diagram of FIG. 8.

Summarizer model output system 306 then outputs the trained student model as the sequence-to-sequence summarizer model 304, as indicated by block 352. The sequence-to-sequence summarizer model 304 is illustratively a smaller model 354 (such as a model that includes 12 encoder layers and 6 decoder layers with 1,024 hidden nodes per layer). The model 304 is illustratively lower latency, as indicated by block 356, than teacher model 300. The sequence-to-sequence summarizer model 304 can take other forms as well and be output in other ways as indicated by block 358. The sequence-to-sequence summarizer model 304 is then deployed as indicated by block 360. It can be deployed to a client computing system 362 or deployed in other ways or in other environments as indicated by block 364.

At some point, student model training system 302 can receive edit inputs showing user edits to summaries generated by user of deployed sequence-to-sequence summarizer model 304. Student model training system 302 can then use machine learning to modify the sequence-to-sequence summarizer models 304 generated by system 302 based on the user edits, as indicated by block 365. Thus, the summarizer models 304 can continue to be improved.

It can thus be seen that the present description describes a system that trains a highly accurate model which is large and relatively high latency. The present description then uses that model to generate training data for a distilled model that is still highly accurate but is lower latency and smaller. The smaller model can be used to summarize textual documents, lists of documents, email threads, among other source content.

It will be noted that the above discussion has described a variety of different systems, components and/or logic. It will be appreciated that such systems, components and/or logic can be comprised of hardware items (such as processors and associated memory, or other processing components, some of which are described below) that perform the functions associated with those systems, components and/or logic. In addition, the systems, components and/or logic can be comprised of software that is loaded into a memory and is subsequently executed by a processor or server, or other computing component, as described below. The systems, components and/or logic can also be comprised of different combinations of hardware, software, firmware, etc., some examples of which are described below. These are only some examples of different structures that can be used to form the systems, components and/or logic described above. Other structures can be used as well.

The present discussion has mentioned processors and servers. In one example, the processors and servers include computer processors with associated memory and timing circuitry, not separately shown. They are functional parts of the systems or devices to which they belong and are activated by, and facilitate the functionality of the other components or items in those systems.

Also, a number of user interface (UI) displays have been discussed. The UI displays can take a wide variety of different forms and can have a wide variety of different user actuatable input mechanisms disposed thereon. For instance, the user actuatable input mechanisms can be text boxes, check boxes, icons, links, drop-down menus, search boxes, etc. The user actuatable input mechanisms can also be actuated in a wide variety of different ways. For instance, the mechanisms can be actuated using a point and click device (such as a track ball or mouse). The mechanisms can be actuated using hardware buttons, switches, a joystick or keyboard, thumb switches or thumb pads, etc. The mechanisms can also be actuated using a virtual keyboard or other virtual actuators. In addition, where the screen on which they are displayed is a touch sensitive screen, the mechanisms can be actuated using touch gestures. Also, where the device that displays them has speech recognition components, the mechanisms can be actuated using speech commands.

A number of data stores have also been discussed. It will be noted data stores they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

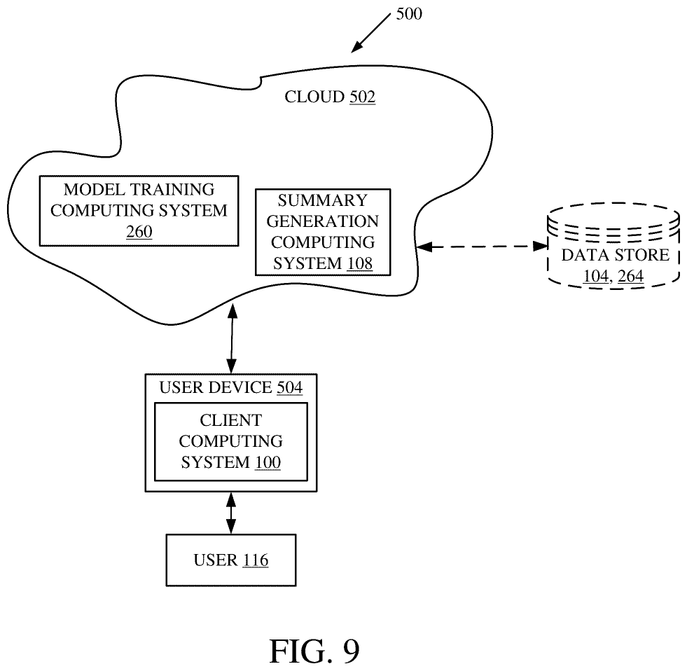

FIG. 9 is a block diagram of a cloud computing architecture 500. Cloud computing provides computation, software, data access, and storage services that do not require end-user knowledge of the physical location or configuration of the system that delivers the services. In various examples, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they components can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the example shown in FIG. 9, some items are similar to those shown in FIGS. 1-8 and they are similarly numbered. FIG. 9 specifically shows that model training computing system 260 and summary generation computing system 108 can be located in cloud 502 (which can be public, private, or a combination where portions are public while others are private). Therefore, user 116 uses a user device 504 to access those systems through cloud 502.

FIG. 9 also depicts another example of a cloud architecture. FIG. 9 shows that it is also contemplated that some elements of computing system 102 can be disposed in cloud 502 while others are not. By way of example, data stores 104, 264 can be disposed outside of cloud 502, and accessed through cloud 502. In another example, other items can be outside of cloud 502. Regardless of where they are located, they can be accessed directly by device 504, through a network (either a wide area network or a local area network), they can be hosted at a remote site by a service, or the items can be provided as a service through a cloud or accessed by a connection service that resides in the cloud. All of these architectures are contemplated herein.

It will also be noted that the systems shown in the above FIGS., or portions of them, can be disposed on a wide variety of different devices. Some of those devices include servers, desktop computers, laptop computers, tablet computers, or other mobile devices, such as palm top computers, cell phones, smart phones, multimedia players, personal digital assistants, etc.

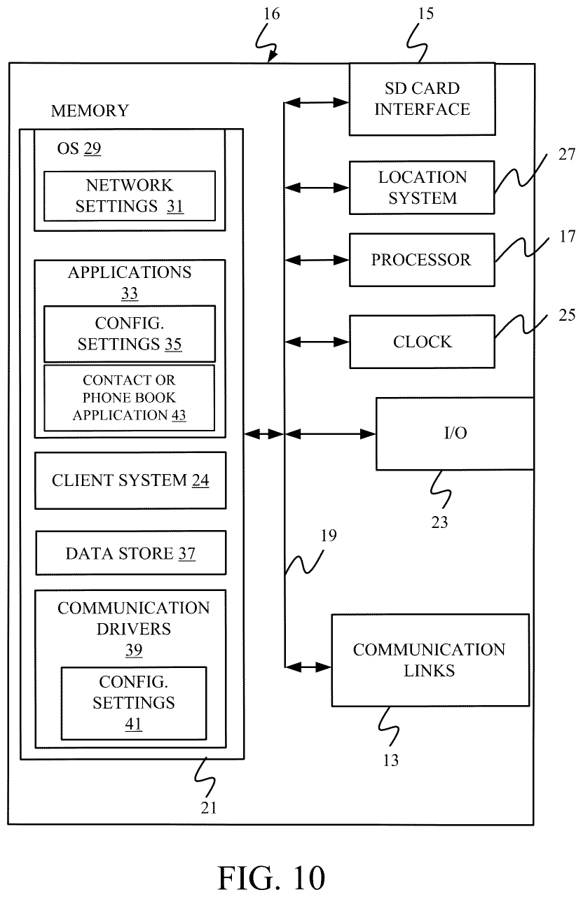

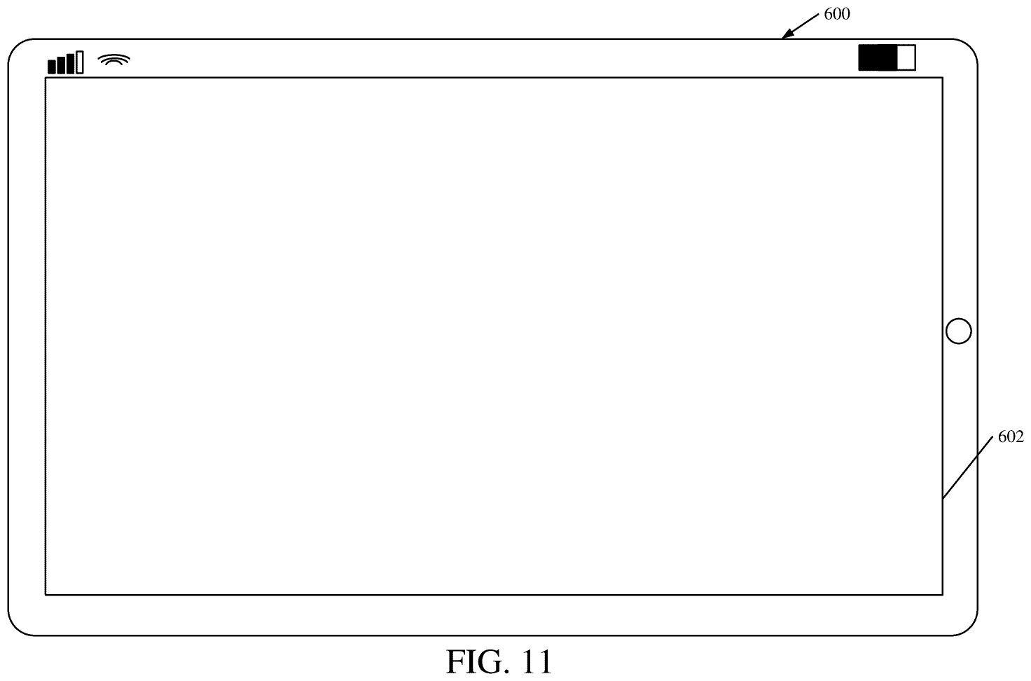

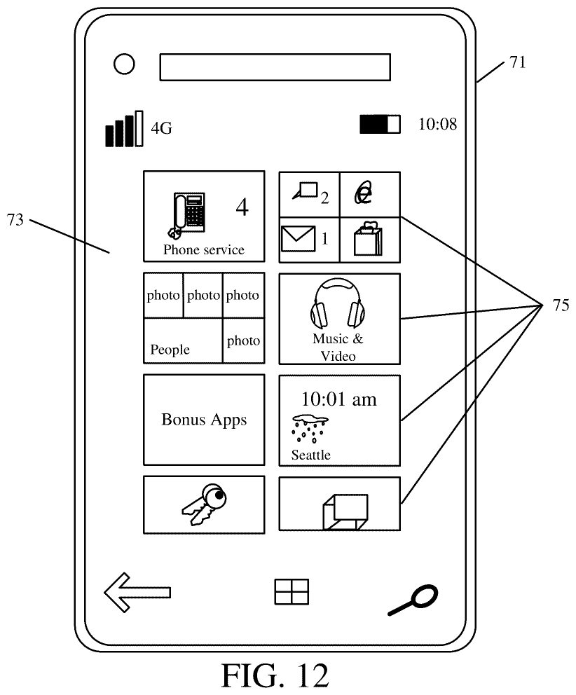

FIG. 10 is a simplified block diagram of one illustrative example of a handheld or mobile computing device that can be used as a user's or client's hand held device 16, in which the present system (or parts of it) can be deployed. FIGS. 11-12 are examples of handheld or mobile devices.

FIG. 10 provides a general block diagram of the components of a client device 16 that can run components computing system 102 or user device 504 or system 116 or that interacts with architecture 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as Wi-Fi protocols, and Bluetooth protocol, which provide local wireless connections to networks.

In other examples, applications or systems are received on a removable Secure Digital (SD) card that is connected to a SD card interface 15. SD card interface 15 and communication links 13 communicate with a processor 17 (which can also embody processors or servers from other FIGS.) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. Memory 21 can also include computer storage media (described below). Memory 21 stores computer readable instructions that, when executed by processor 17, cause the processor to perform computer-implemented steps or functions according to the instructions. Similarly, device 16 can have a client system 24 which can run various applications or embody parts or all of architecture 100. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 11 shows one example in which device 16 is a tablet computer 600. In FIG. 11, computer 600 is shown with user interface display screen 602. Screen 602 can be a touch screen (so touch gestures from a user's finger can be used to interact with the application) or a pen-enabled interface that receives inputs from a pen or stylus. Computer 600 can also use an on-screen virtual keyboard. Of course, it might also be attached to a keyboard or other user input device through a suitable attachment mechanism, such as a wireless link or USB port, for instance. Computer 600 can also illustratively receive voice inputs as well.

FIG. 12 shows that the device can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

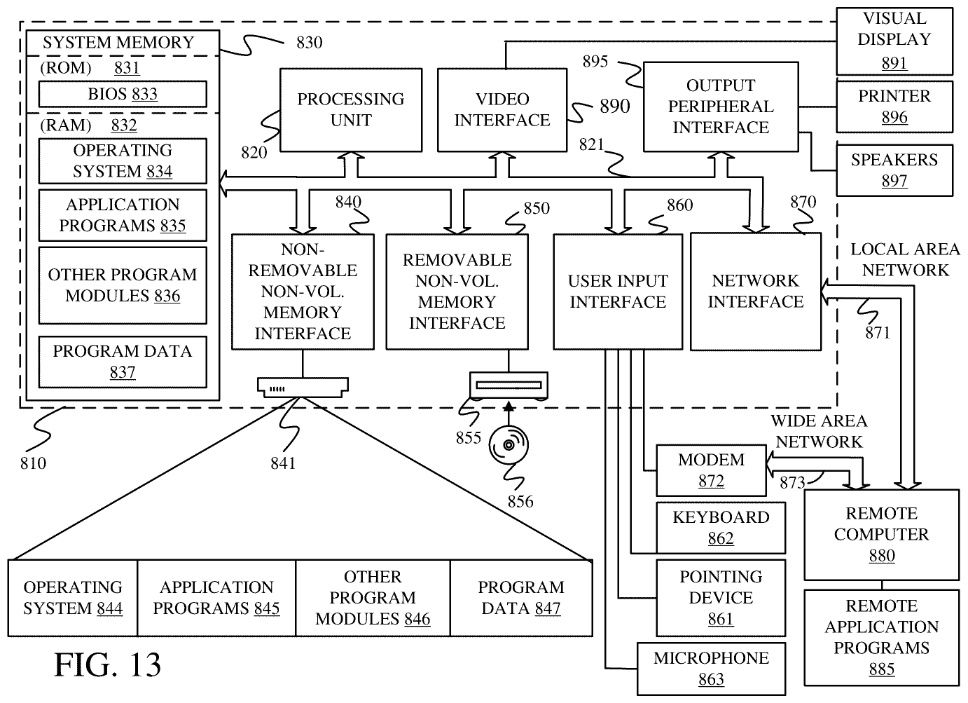

FIG. 13 is one example of a computing environment in which architectures and systems in previous FIGS., or parts of it, (for example) can be deployed. With reference to FIG. 10, an example system for implementing some embodiments includes a computing device in the form of a computer 810 programmed to operate as described above. Components of computer 810 may include, but are not limited to, a processing unit 820 (which can comprise processors or servers from previous FIGS.), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to previous FIGS. can be deployed in corresponding portions of FIG. 13.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 13 illustrates operating system 834, application programs 835, other program modules 836, and program data 837.

The computer 810 may also include other removable/non-removable volatile/nonvolatile computer storage media. By way of example only, FIG. 13 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 13, provide storage of computer readable instructions, data structures, program modules and other data for the computer 810. In FIG. 13, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 13 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 13 illustrates remote application programs 885 as residing on remote computer 880. It will be appreciated that the network connections shown are exemplary and other means of establishing a communications link between the computers may be used.

It should also be noted that the different examples described herein can be combined in different ways. That is, parts of one or more examples can be combined with parts of one or more other examples. All of this is contemplated herein.

Example 1 is a computer system, comprising:
a user interface display mechanism that displays a source document on a source document display portion of a user interface display and a summarization actuator on a control display portion of the user interface display;
a trigger detector that detects a user input indicative of user actuation of the summarization actuator;
a source text extraction system extracting textual content from the source document based on the detected user actuation of the summarization actuator;
a sequence-to-sequence summarizer that transforms the textual content extracted from the source document to a summary of the textual content extracted from the source document; and
a user experience generation system that displays the summary with the source document.

Example 2 is the computer system of any or all previous examples and further comprising:
a text dividing system configured to segment the textual content into a plurality of different sections, and wherein the sequence-to-sequence summarizer is configured to generate a different summary corresponding to each of the plurality if different sections.

Example 3 is the computer system of any or all previous examples and further comprising:
a summary merging system configured to merge the different summaries corresponding to each of the plurality of different sections into the summary of the textual content extracted from the source document.

Example 4 is the computer system of any or all previous examples wherein the source document comprises a thread of electronic mail (email) messages and wherein the source text extraction system comprises:
an email thread processor configured to extract a body of each message in the thread of email messages; and
a text extractor configured to extract metadata indicative of a sender of each message in the thread of email messages.

Example 5 is the computer system of any or all previous examples wherein the sequence-to-sequence summarizer is configured to generate a separate summary of messages sent by each sender in the thread of email messages.

Example 6 is the computer system of any or all previous examples wherein the source document comprises a list of documents and wherein the source text extraction system comprises:
an email thread processor configured to access each document in the list of documents, extract textual content from each document in the list of documents, and extract metadata identifying each of the documents in the list of documents.

Example 7 is the computer system of any or all previous examples further comprising:
a correlation suggestion generator configured to generate a correlation indicator indicative of an insertion point in the source document for the summary and output the correlation indicator.

Example 8 is the computer system of any or all previous examples wherein the user experience generation system is configured to conduct a user experience enabling user interaction with the summary and the correlation indicator.

Example 9 is a computer system, comprising:
a first model training system configured to train a first summarization model that receives a textual input and generates a summary of the textual input;
a training data accessing system configured to obtain a plurality of documents;
a distillation system configured to generate, with the first summarization model, a summary corresponding to each document of the plurality of documents;
a training data pair generator that generates a plurality of document/summary pairs, each document/summary pair comprising a document, of the plurality of documents, and the corresponding summary; and
a second model training system that trains a sequence-to-sequence summarizer model based on the plurality of document/summary pairs.

Example 10 is the computer system of any or all previous examples wherein the second model training system comprises a machine learning system that trains the sequence-to-sequence summarizer model as an artificial neural network.

Example 11 is the computer system of any or all previous examples and further comprising:
a user experience generation system configured to display a summary generated by the sequence-to-sequence summarizer model for user interaction, receive a user correction of the summary, and wherein the second model training system is configured to re-train the sequence-to-sequence summarizer model based on the user correction.

Example 12 is a computer implemented method, comprising:
displaying a source document on a source document display portion of a user interface display;
displaying a summarization actuator on a control display portion of the user interface display;
detecting a user input indicative of user actuation of the summarization actuator;
extracting textual content from the source document based on the detected user actuation of the summarization actuator;
transforming, with a sequence-to-sequence summarizer, the textual content extracted from the source document to a summary of the textual content extracted from the source document; and
displaying the summary with the source document.

Example 13 is the computer implemented method of any or all previous examples wherein transforming comprises:
segmenting the textual content into a plurality of different sections; and
generating a different summary corresponding to each of the plurality if different sections.

Example 14 is the computer implemented method of any or all previous examples wherein transforming comprises:
merging the different summaries corresponding to each of the plurality of different sections into the summary of the textual content extracted from the source document.

Example 15 is the computer implemented method of any or all previous examples wherein the source document comprises a thread of electronic mail (email) messages and wherein extracting textual content comprises:
extracting a body of each message in the thread of email messages; and
extracting metadata indicative of a sender of each message in the thread of email messages.

Example 16 is the computer implemented method of any or all previous examples wherein transforming comprises:
generating a separate summary of messages sent by each sender in the thread of email messages.

Example 17 is the computer implemented method of any or all previous examples wherein the source document comprises a list of documents and wherein extracting textual content comprises:
accessing each document in the list of documents;
extracting textual content from each document in the list of documents; and
extracting metadata identifying each of the documents in the list of documents.

Example 18 is the computer implemented method of any or all previous examples further comprising:
generating a correlation indicator indicative of an insertion point in the source document for the summary; and
outputting the correlation indicator.

Example 19 is the computer implemented method of any or all previous examples and further comprising:
conducting a user experience enabling user interaction with the summary and the correlation indicator.

Example 20 is the computer implemented method of any or all previous examples wherein displaying the summary comprises:
displaying the summary at the insertion point in the source document.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer system, comprising:
a user interface display mechanism that displays a source document on a source document display portion of a user interface display and a summarization actuator on a control display portion of the user interface display;
a trigger detector that detects a user input indicative of user actuation of the summarization actuator;
a source text extraction system extracting textual content from the source document based on the detected user actuation of the summarization actuator;
a sequence-to-sequence summarizer that transforms the textual content extracted from the source document to a summary of the textual content extracted from the source document; and
a user experience generation system that displays the summary with the source document.

2. The computer system of claim 1 and further comprising:
a text dividing system configured to segment the textual content into a plurality of different sections, and wherein the sequence-to-sequence summarizer is configured to generate a different summary corresponding to each of the plurality if different sections.

3. The computer system of claim 2 and further comprising:
a summary merging system configured to merge the different summaries corresponding to each of the plurality of different sections into the summary of the textual content extracted from the source document.

4. The computer system of claim 1 wherein the source document comprises a thread of electronic mail (email) messages and wherein the source text extraction system comprises:
an email thread processor configured to extract a body of each message in the thread of email messages; and
a text extractor configured to extract metadata indicative of a sender of each message in the thread of email messages.

5. The computer system of claim 4 wherein the sequence-to-sequence summarizer is configured to generate a separate summary of messages sent by each sender in the thread of email messages.

6. The computer system of claim 1 wherein the source document comprises a list of documents and wherein the source text extraction system comprises:
an email thread processor configured to access each document in the list of documents, extract textual content from each document in the list of documents, and extract metadata identifying each of the documents in the list of documents.

7. The computer system of claim 1 further comprising:
a correlation suggestion generator configured to generate a correlation indicator indicative of an insertion point in the source document for the summary and output the correlation indicator.

8. The computer system of claim 7 wherein the user experience generation system is configured to conduct a user experience enabling user interaction with the summary and the correlation indicator.

9. A computer system, comprising:
a first model training system configured to train a first summarization model that receives a textual input and generates a summary of the textual input;
a training data accessing system configured to obtain a plurality of documents;
a distillation system configured to generate, with the first summarization model, a summary corresponding to each document of the plurality of documents;
a training data pair generator that generates a plurality of document/summary pairs, each document/summary pair comprising a document, of the plurality of documents, and the corresponding summary; and
a second model training system that trains a sequence-to-sequence summarizer model based on the plurality of document/summary pairs.

10. The computer system of claim 9 wherein the second model training system comprises a machine learning system that trains the sequence-to-sequence summarizer model as an artificial neural network.

11. The computer system of claim 9 and further comprising:
a user experience generation system configured to display a summary generated by the sequence-to-sequence summarizer model for user interaction, receive a user correction of the summary, and wherein the second model training system is configured to re-train the sequence-to-sequence summarizer model based on the user correction.

12. A computer implemented method, comprising:
displaying a source document on a source document display portion of a user interface display;
displaying a summarization actuator on a control display portion of the user interface display;
detecting a user input indicative of user actuation of the summarization actuator;
extracting textual content from the source document based on the detected user actuation of the summarization actuator;
transforming, with a sequence-to-sequence summarizer, the textual content extracted from the source document to a summary of the textual content extracted from the source document; and
displaying the summary with the source document.

13. The computer implemented method of claim 12 wherein transforming comprises:
segmenting the textual content into a plurality of different sections; and
generating a different summary corresponding to each of the plurality if different sections.

14. The computer implemented method of claim 13 wherein transforming comprises:
merging the different summaries corresponding to each of the plurality of different sections into the summary of the textual content extracted from the source document.

15. The computer implemented method of claim 12 wherein the source document comprises a thread of electronic mail (email) messages and wherein extracting textual content comprises:
extracting a body of each message in the thread of email messages; and
extracting metadata indicative of a sender of each message in the thread of email messages.

16. The computer implemented method of claim 15 wherein transforming comprises:
generating a separate summary of messages sent by each sender in the thread of email messages.

17. The computer implemented method of claim 12 wherein the source document comprises a list of documents and wherein extracting textual content comprises:
accessing each document in the list of documents;
extracting textual content from each document in the list of documents; and
extracting metadata identifying each of the documents in the list of documents.

18. The computer implemented method of claim 12 further comprising:
generating a correlation indicator indicative of an insertion point in the source document for the summary; and
outputting the correlation indicator.

19. The computer implemented method of claim 18 and further comprising:
conducting a user experience enabling user interaction with the summary and the correlation indicator.

20. The computer implemented method of claim 18 wherein displaying the summary comprises:
displaying the summary at the insertion point in the source document.
